(19) United States
(12) Patent Application Publication
(10) Pub. No.: US 2019/0234122 A1
(43) Pub. Date: Aug. 1, 2019

(54) HANDLE DEVICE WITH A SURFACE-FLUSH HANDLE

(71) Applicant: HUF HÜLSBECK & FÜRST GMBH & CO. KG, Velbert (DE)

(72) Inventors: Matthias Löw, Ratingen (DE); Willi Put, Winterswijk-Meddo (NL)

(21) Appl. No.: 16/317,521

(22) PCT Filed: Jun. 23, 2017
(86) PCT No.: PCT/EP2017/065582

§ 371 Date: Jan. 11, 2019

(30) Foreign Application Priority Data
Jul. 11, 2016 (DE) 10 2016 112 689.6

(51) Int. Cl. E05B 85/10; E05B 81/76

(52) U.S. Cl. CPC E05B 85/107; E05B 81/76; E05B 85/103

(57) ABSTRACT

The present invention relates to a handle device (10) for a movable part, in particular a door, of a motor vehicle, comprising a grip part (11) for activating the movable part, a carrier element (12) for fastening the handle device (10) to the movable part, wherein the grip part (11) is mounted on the carrier element (12) so as to be movable between a resting position (I) and an operating position (II), wherein, in the resting position (I), the grip part (11) can be arranged such that an outer surface (11a) thereof is flush-mounted with an outer side (100) of the movable part, wherein, in the operating position (II), the grip part (11) can be extended out of an opening (101) in the outer side (100) of the movable part, and wherein, in the operating position (II), the grip part (11) can be used for opening the movable part, and an actuation unit (20) for actuating the grip part (11) between the resting position (I) and the operating position (II), characterized in that the actuation unit (20) is configured such that the outer surface (11a) of the grip part (11) can always be displaced in parallel with the outer side (100) of the movable part, between the resting position (I) and the operating position (II).

The present invention is directed to a device for a movable part, in particular a door, of a motor vehicle according to the preamble of claim 1. In this case, the handle device comprises a grip part for activating the movable part, a carrier element for fastening the handle device to the movable part, wherein the grip part is mounted on the carrier element so as to be movable between a resting position and an operating so position, wherein, in the resting position, the grip part can be arranged such that an outer surface thereof is flush-mounted on an outer side of the movable part, wherein, in the operating position, the grip part can be extended out of an opening in the outer side of the movable part, and wherein, in the operating position, the grip part can be used for opening the movable part, and said handle device comprising an actuation unit for actuating the grip part between the resting position and the operating position.

Handle devices comprising flush-mounted grip parts that are movable between a retracted resting position and an extended operating position are known in principle. However, known handle devices comprise complicated actuation units for actuating the grip part, which units require a relatively large amount of installation space. Actuation units of this kind furthermore allow for a complex movement sequence of the grip part. However, this significantly reduces the comfort of handle devices of this kind. In the case of complicated actuation units, there is furthermore the risk that the grip part may pause in one of the positions or in an intermediate position and no longer function correctly. If the grip part remains unintentionally in the operating position it then protrudes, in a disruptive manner, from the outer side of the door. However, the advantages of a flush-mounted handle device are lost thereby.

The object of the present invention is therefore that of providing a handle device for a flush-mounted grip part, which handle device comprises a simple actuation unit and exhibits stable operation and a high level of reliability when the grip part is actuated. In order to achieve the above object, a handle device having the features of the main claim, in particular having the features from the characterizing part, is proposed. Further advantageous embodiments of the invention can be found in the dependent claims, the description and the drawings.

According to the invention, the actuation unit is configured such that the outer surface of the grip part (i.e. handle part) can always be displaced in parallel with the outer side of the door, between the resting position and the operating position. Within the context of the present application, the term “door” is used for a movable part, a movable flap, a movable cover or the like. In this case, the carrier element (i.e. support element) may form part of a housing of the handle device and/or be configured as a frame structure and be used as a mounting aid for mounting the handle device on the movable part.

In this case, the inventive concept consists in providing a simple actuation unit comprising as few components as possible, which unit allows for simple, stable and error-free transfer of the grip part between the resting position and the operating position. Provided that the outer surface of the grip part is displaced in parallel with the outer side of the door, the risk that the grip part might pause in one of the intermediate positions is advantageously reduced. This means that the displacement path of the grip part between the resting position and the operating position can be simplified, with the result that the actuation of the grip part can also be simplified. This in addition allows for the actuation effect to be transmitted to the grip part in a stable manner. In this case, in order to transmit the actuation effect to the grip part in a simple and stable manner the actuation unit can make do with just one actuation element, which may be a drive shaft or a drive rod, and with just one transmission element. In other words, the actuation unit can enable, by means of just one transmission element between the drive shaft and the grip part, for the movement of the actuation element along the drive shaft, for example in parallel with the outer side of the door, to be transformed into the movement of the grip part, for example substantially perpendicularly to the outer side of the door, along a linear path, or approximately perpendicularly to the outer side of the door, along a curved path.

It is possible, according to the invention, for the actuation unit to comprise a linear drive. An actuation unit of this kind causes a translational movement at a drive shaft or at an actuation element, which movement is simple and stable and can transmit large actuation forces. The actuation unit can consequently cause the movement of the grip part along a specified displacement path in a stable manner by means of the linear drive. The displacement path can advantageously be co-formed by means of a transmission link in the transmission chain of the actuation effect, between the drive shaft and the grip part. In this case, it is conceivable that it may be possible to bring about a curved movement of the grip part from a linear movement of the drive shaft. It is likewise conceivable for it to be possible for the linear movement of the drive shaft to be transformed into a linear movement of the grip part that is likewise linear but is offset by a specified angle, for example by 90°. The actuation unit comprising the linear drive can furthermore generate a relatively large actuation effect in small installation space. Moreover, the linear drive can generate different forces and can thus permit different speeds during the displacement of the grip part. In this case, the linear drive may be formed as a hydraulic, pneumatic or electromechanical drive.

It is furthermore possible, within the context of the invention, for the actuation unit to comprise an actuation element, in particular in the form of a drive rod. In this case, the actuation element may function as a movable part of the actuation unit, which part is actuated translationally. In this case, it is advantageous for the actuation element to be able to transmit the actuation effect in a stable manner along a linear drive axis. Moreover, it is possible, within the context of the invention, that the actuation element may be displaceable linearly and in parallel with the outer side of the movable part and the outer surface of the grip part. As a result, use can be made of the installation space along the door, it being possible to advantageously reduce the installation space in the direction transverse to the door, which space is often limited. As a result, the door can be formed so as to be lighter-weight and thinner, which facilitates the process of mounting the door, makes the design of the door lighter-weight and simpler, and increases the operating comfort of the movable part.

It is moreover possible, within the context of the invention, that the actuation unit may comprise at least one transmission element for transmitting the actuation effect from the actuation element to the grip part. In this case, the transmission element is intended to be a single transmission link in the drive chain between the actuation element and the grip part, which link is configured to divert the actuation direction from the actuation element and transmit said direction to the grip part. An advantage in this case is that it is thereby possible to bring about an offset movement of the grip part, for example offset by an angle of approximately 90°, from a linear movement of the actuation element. As a result, a transformed, but still stable, movement of the grip part can be brought about from a simple and stable movement of the actuation element.

The invention can furthermore provide for the actuation unit to be able to comprise two transmission elements, which may engage on the actuation element at the end thereof. The same transmission link in the drive chain is intended in this case, which link can be formed twice. In this case, the two transmission elements symmetrically enclose the grip part at the two end sides of the grip part. In this case, the two transmission elements act synchronously on the same transmission link in the drive chain, and in fact create two symmetrical points of application on the actuation element and likewise two symmetrical points of application on the grip part, in order to implement the transmission effect from the actuation element to the grip part on both sides and to thus bring about a stabilizing effect. An advantage in this case is that even an elongate grip can be actuated in a uniform and thus error-free manner using two end transmission elements.

It is furthermore possible according to the invention that a connecting element, for example in the form of a connecting rod, may be provided between the two transmission elements, in order to synchronize the movement of the transmission elements. In this case, the connecting element may extend between the transmission elements in the manner of a conducting projection and be oriented so as to be substantially in parallel with the outer side of the door and with the outer surface of the grip part. In this case, the connecting element can advantageously make uniform the transmission effect from the actuation element to the two transmission elements, and the movement of the two transmission elements. In this case, the connecting element may in part imitate the movement of the grip part, in that the connecting element can be moved substantially in parallel with the outer side of the door. The invention may furthermore provide for the connecting element to be able to be in each case pivotably mounted about a fourth axis, which axis is movable with the first transmission element and with the second transmission element. In this case, it is advantageous for it to be possible to thereby change the angle between the actuation element and the transmission elements, and between the transmission elements and the connecting element, when transmitting the actuation effect from the actuation element to the grip part.

It is furthermore possible, according to the invention, that the at least one transmission element may be able to be mounted on the actuation element so as to be pivotable about a first axis that is movable with the actuation element, and/or to be mounted on the grip part so as to be pivotable about a second axis that is movable with the grip part. A transmission chain for the actuation effect having a variable angle can thus advantageously be formed between the actuation element and the transmission element and between the transmission element and the grip part. In this case, use can be made of the installation space along the outer side of the door in order to implement a linear movement of the actuation element in parallel with the outer side of the door. The pivotable transmission element can then divert this movement in the direction transverse to the outer side of the door, even in a small installation space, such that the grip part can move out of the opening in the door so as to be substantially perpendicular to the outer side of the door.

Advantageously, the actuation element can further comprise at least one stop surface which can, in an emergency, be brought into operative connection with the grip part in order to assist the actuation effect on the grip part. However, in normal operation the stop surface does not have any operative effect on the grip part. In this case, the advantage of this is that, in an emergency, for example if the handle device freezes, it is possible to form an additional and direct attack surface between the actuation element and the grip part, in order to increase the actuation effect on the grip part and to break any ice that may be present in a gap between the opening in the door and the outer surface of the grip part.

It is furthermore possible, within the context of the invention, that the grip part may comprise at least one emergency element which, in an emergency, can be brought into operative connection with the stop surface in order to assist the actuation effect on the grip part, the emergency element in particular being spaced apart from the stop surface under normal circumstances. In this case, the transmission element may comprise a slot at the point of application on the actuation element in order to implement a certain amount of overrun for the actuation element, in the event of the grip part freezing in the opening in the movable part, until the stop surface of the actuation element can be brought into operative engagement with the emergency element of the grip part. The handle device according to the invention can thus advantageously implement an ice-breaker function.

It is furthermore conceivable, according to the invention, that the at least one transmission element may be configured in the form of a straight or curved lever. A component of this kind is economical to produce and simple to mount. A straight transmission element is particularly stable during actuation, a curved transmission element being able to advantageously reduce the necessary installation space for transmitting the actuation effect.

It is moreover possible, within the context of the invention, that the carrier element may comprise at least one slotted guide for stabilizing the movement of the grip part between the resting position and the operating position. The movement of the grip part can thus be specified by the shape of the slotted guide and can act as an additional guide aid for the transmission mechanism by means of the actuation unit. In this case it is also conceivable that the carrier element may comprise two slotted guides in order to support the movement of the grip part from two end sides. This can increase the stability of the guidance of the grip part even further.

It is furthermore conceivable, within the meaning of the invention, that it may be possible for the at least one slotted guide, in particular the two slotted guides, to be configured so as to allow a movement of the grip part substantially perpendicularly to the outer side of the movable part and to the outer surface of the grip part. As a result, the grip part may have a movement direction that is substantially perpendicular to the outer side of the movable part. As a result, the transfer of the grip part between the resting position and the operating position can be achieved in a particularly stable and controlled manner. It is furthermore possible, according to the invention, that the at least one slotted guide, in particular the two slotted guides, may be able to be oriented so as to be perpendicular to the outer side of the movable part and to the outer surface of the grip part. The at least one slotted guide, in particular the two slotted guides, can thus be produced in a simple and uncomplicated manner. A slotted guide or slotted guides of this kind enable to implement the simple movement sequence of the grip part within the meaning of the invention in a simple manner, allowing for stable and reliable transfer of the grip part between the resting position and the operating position.

In this case, it is furthermore conceivable that the grip part may comprise a cam, in particular two cams, which may engage with the slotted guide, in particular with the two slotted guides. This can allow for simple and reliable interaction between the slotted guide and the grip part.

The invention may furthermore provide that the carrier element may comprise at least one stop element for limiting the movement of the grip part, between the resting position and the operating position, laterally and/or to the rear. In this case, it is advantageous for the stop element not to be able to accidentally implement an undesired movement of the grip part outside of the specified displacement path. This furthermore avoids the risk of the carrier element pausing during the movement. Furthermore, it is also conceivable that the carrier element may comprise two stop elements in order to support the movement of the grip part from two end sides. As a result, the movement of the grip part can be implemented in an even more stable and reliable manner. The carrier element may furthermore comprise one, two or three stop elements behind the grip part in order to prevent the grip part from retracting via a resting position.

It is furthermore possible, within the context of the invention, that the actuation unit may be configured so as to be self-locking. This can achieve the advantage that the grip part can be protected, at least in the operating position, against abrupt slamming or undesired deflection. Undesired and too strong a manipulation of the grip part can thus be prevented. It is possible in this case that the actuation element and the transmission element may be able to be oriented so as to be approximately perpendicular to one another in the operating position of the grip part, in order to prevent undesired transfer of the grip part out of the operating position and into the resting position. The actuation element and the transmission element can thus form a T-piece which is blocked against abrupt striking of the transmission element on the actuation element. However, the T-piece can be released again by means of desired and moderate actuation of the grip part or of the actuation unit within the meaning of the invention, in order to transfer the grip part out of the operating position and into the resting position. In the resting position of the grip part, the actuation element and the transmission element can then be arranged so as to be at an acute angle relative to one another.

It is conceivable, according to the invention, that, in the operating position of the grip part, the actuation element and the at least one transmission element may be able to be arranged so as to be at an angle of from 75° to 90°, in particular 80° to 88°, preferably 84° to 86°, relative to one another, in order to prevent undesired transfer of the grip part out of the operating position and into the resting position. An angle of this kind is advantageously close enough to 90° for the effect of the transmission element striking the actuation element to inhibit a release of the substantially mutually perpendicular orientation thereof. However, an angle of this kind can advantageously permit desired and moderate actuation of the grip part or of the actuation unit within the meaning the invention in order to transfer the grip part out of the operating position and into the resting position.

It may furthermore be possible according to the invention that at least one spring element, in particular two spring elements, may be provided in order to support the movement of the grip part out of the operating position and into the resting position. Releasing of the substantially mutually perpendicular orientation of the actuation element and the transmission element, or in other words release of a T-piece between the transmission element and the actuation element, can thus advantageously be assisted by a spring force in order to resiliently release the self-locking of the actuation unit, in the operating position, against careful actuation.

In this case, a first spring element may strike the actuation element in order to load the actuation element out of an extended position and into a retracted position, the grip part being in the resting position when the actuation element is in the retracted position, and the grip part being in the operating position when the actuation element is in the extended position. As a result, the actuation element can be loaded into the retracted position in order to ensure that the grip part can be transferred into the resting position by means of moderate actuation, even in spite of a self-locking effect of the actuation unit.

It is furthermore possible that a second spring element may strike the grip part in order to load the grip part out of the operating position and into the resting position. It is thereby possible to achieve the advantage that the grip part can reliably reach the resting position from the operating position by means of slow and deliberate actuation, and cannot pause in the extended operating position.

Moreover, it is conceivable that the at least one transmission element may be configured in the form of a triangle. It is thus possible to achieve the advantage that the transmission element can comprise three points of application in order to engage on the actuation element by means of one point of application, to engage on the grip part by means of the second point of application, and finally to form a pivotable axis by means of a third point of application, which axis can be used for pivotably fastening the transmission element to the carrier element. In this case, the pivotable axis can advantageously function as a support point for the transmission element on the carrier element. The transmission element can thus be actuated in a more stable and more reliable manner, and can itself transmit the actuation force to the grip part in a more stable manner. As a result, the linear movement of the actuation element can initially be transformed into a curved movement of the transmission element, in order to finally allow a corresponding movement of the grip part that is substantially perpendicular to the outer side of the door.

It is furthermore possible, within the context of the invention, that the at least one transmission element may comprise a slot, in particular one slot, respectively, towards the actuation element, in order to receive a first axis, which is movable with the actuation element, in a linearly movable and pivotable manner. A plurality of advantages can be enabled thereby. Firstly, this can enable for a linear movement of the actuation element to be able to be transformed into a curved movement of the transmission element by means of a variable radius of the transmission element being able to engage with the actuation element, along the slot. Secondly, this can ensure that there can still be clearance along the slot when the grip part is in the operating position, in order for it to be possible for the grip part to still be pulled slightly further out of the opening in the outer side of the door when the actuation element and the transmission element are stationary, and for the door to be opened for example. It is thus possible for the grip part to be able to be movable in the operating position of the grip part, in order to be used for actuating the door.

It is furthermore possible, according to the invention, that the at least one transmission element may be able to be mounted on the carrier element so as to be pivotable about a third, fixed axis, in particular one such axis, respectively. One point of application of the transmission element can thus be supported on the carrier element in order to reliably transfer the actuation effect to the grip part.

The invention may furthermore provide that the at least one transmission element may comprise a slot, in particular one slot, respectively, towards the grip part, in order to receive a second axis, which is movable with the grip part, in a pivotable manner and so as to be linearly movable. It is thereby possible to achieve the advantage that the curved movement of the transmission element can be transformed into a linear movement of the grip part out of the resting position and into the operating position, and vice versa. A linear movement of the grip part is advantageous because it can be easily and reliably supported on the carrier element, for example using a slotted guide, and because it is the least susceptible to error.

It is furthermore conceivable, within the meaning of the invention, that the carrier element may comprise at least one stop guide in order to laterally stabilize the movement of the grip part between the resting position and the operating position, wherein in particular the carrier element can comprise two stop guides in order to support the movement of the grip part from two end sides. As a result, at least one continuous stop can be created on one end side or on two end sides of the grip part in order to ensure that the grip part does not deflect out to the side and that said part can reliably follow the specified displacement path.

It is furthermore possible, within the context of the invention, that the grip part may comprise a sensor for automatically initiating opening of the movable part when a user's hand grasps a handle recess on the grip part. Simple and intuitive activation of the door can thus be made possible, and this can be implemented in a fully automatic manner without pulling the grip part. It is moreover possible, within the context of the invention, that the grip part may comprise a switch on the outer surface for automatically initiating a transfer of the grip part out of the operating position and into the resting position. A user would intuitively wish to manipulate the point on the outer surface of the grip part in order to push in the grip part. It is furthermore possible, within the context of the invention, that the grip part may comprise a sensor, for example on an upper flat side, in order to automatically initiate locking of the movable part by tapping the sensor. Locking of the door can be triggered in a comfortable and replicable manner by means of tapping the upper face of the grip part. Manipulation of the grip part can thus be fully automated, wherein the corresponding sensors and switches can be positioned at points that a user can find intuitively for the relevant action. Operation of the handle device can thus be made even more comfortable.

According to the invention, the handle device can be formed as a component of a Keyless-Go system of a motor vehicle which can in particular lock and/or unlock the movable part without a mechanical lock cylinder. An automatic system can thus be provided for unlocking or for locking the motor vehicle without actively using a car key. An automatically extending and retracting grip part can advantageously increase the operating comfort of the motor vehicle.

It is further conceivable that the handle device may comprise a transceiver unit for executing a user authorization request. The authorization of a user who is about to manipulate the handle device can thus advantageously be verified directly at the handle device. It is conceivable in this case that the transceiver unit may be arranged directly in the movable grip part or be installed in a fixed manner on the carrier element.

Further advantageous measures and features of the invention can be found in the following description and in the drawings. The drawings show the invention in a plurality of embodiments. In the drawings:

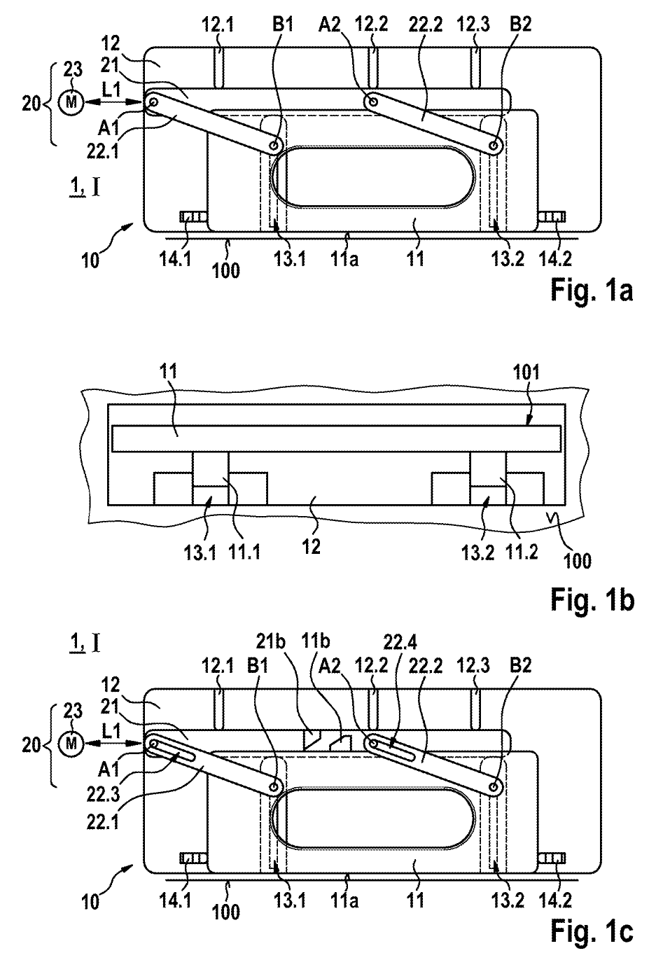

FIG. 1a shows, by way of example, a handle device according to the invention, from above

FIG. 1b shows, by way of example, a handle device according to the invention, from an end side,

FIG. 1c shows, by way of example, a further embodiment of the handle device according to the invention,

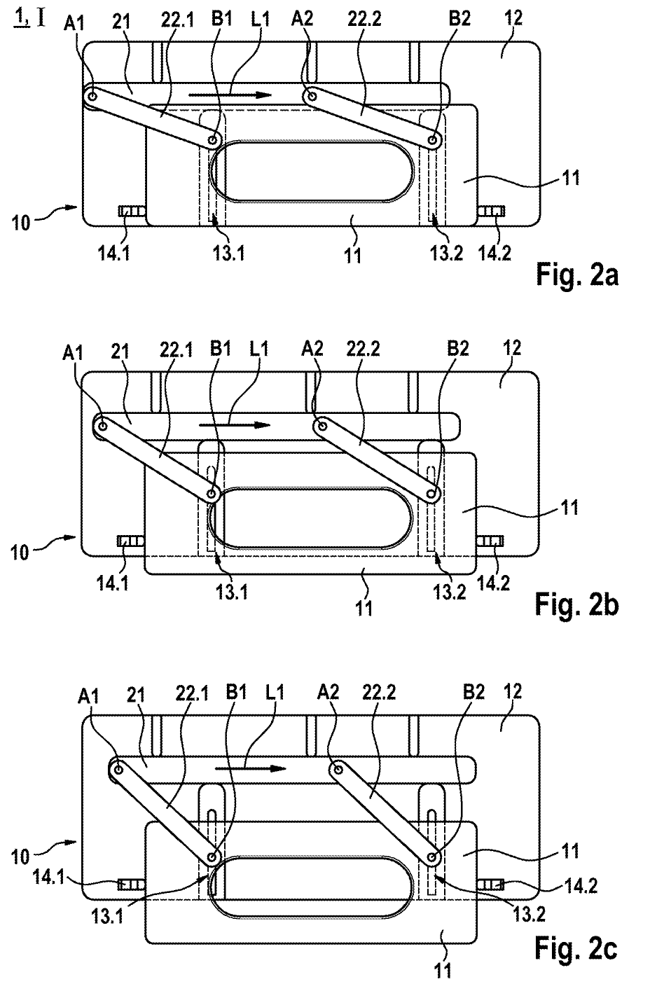

FIGS. 2a to 2e show, by way of example, a displacement path of a grip part between a resting position and an operating position using the handle device according to FIG. 1,

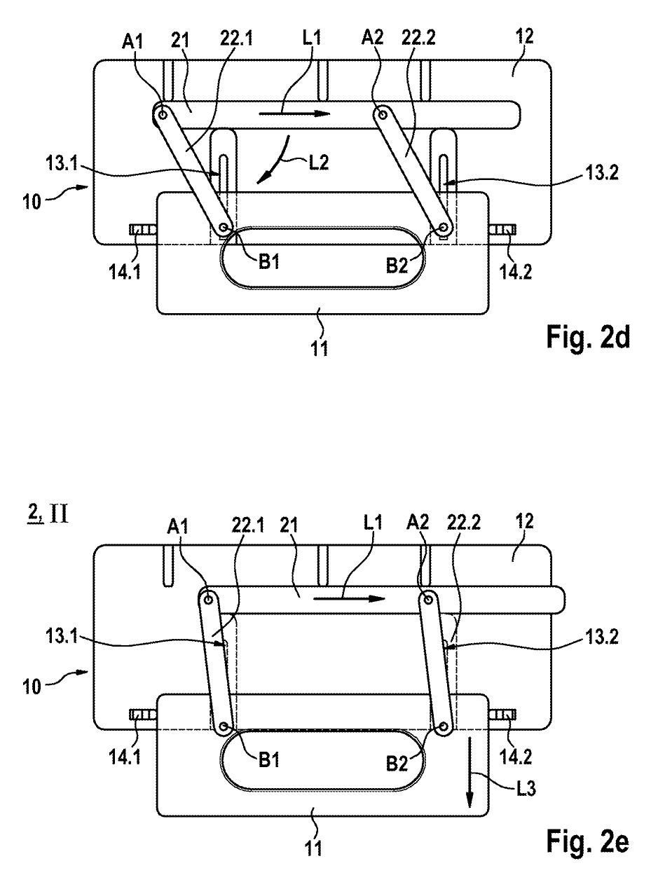

FIG. 3 shows, by way of example, a further embodiment of the handle device according to the invention, comprising spring elements and having the grip part in the operating position,

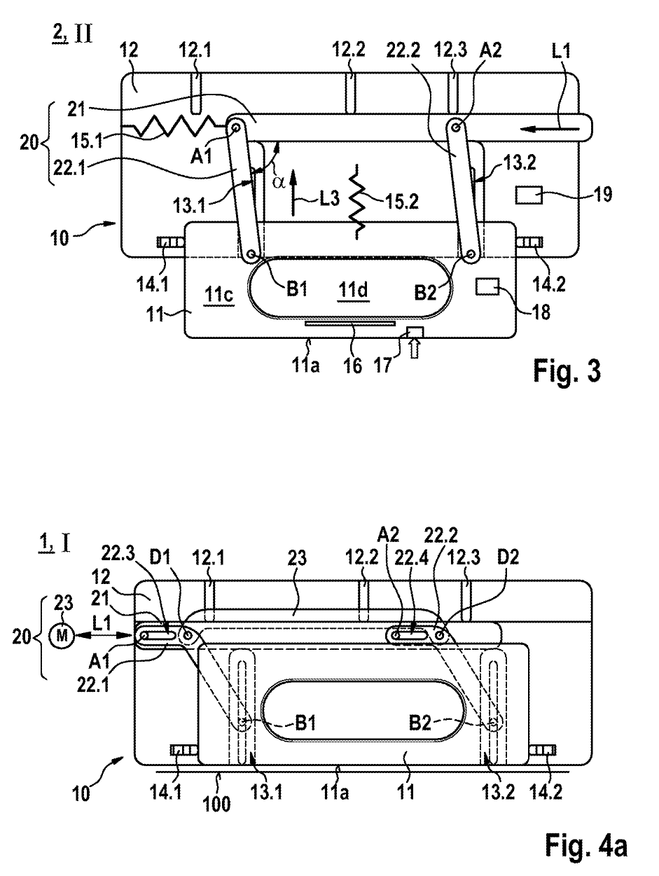

FIG. 4a shows, by way of example, a further embodiment of the handle device according to the invention, having the grip part in the resting position,

FIG. 4b shows the handle device according to the invention according to FIG. 4a, having the grip part in the operating position,

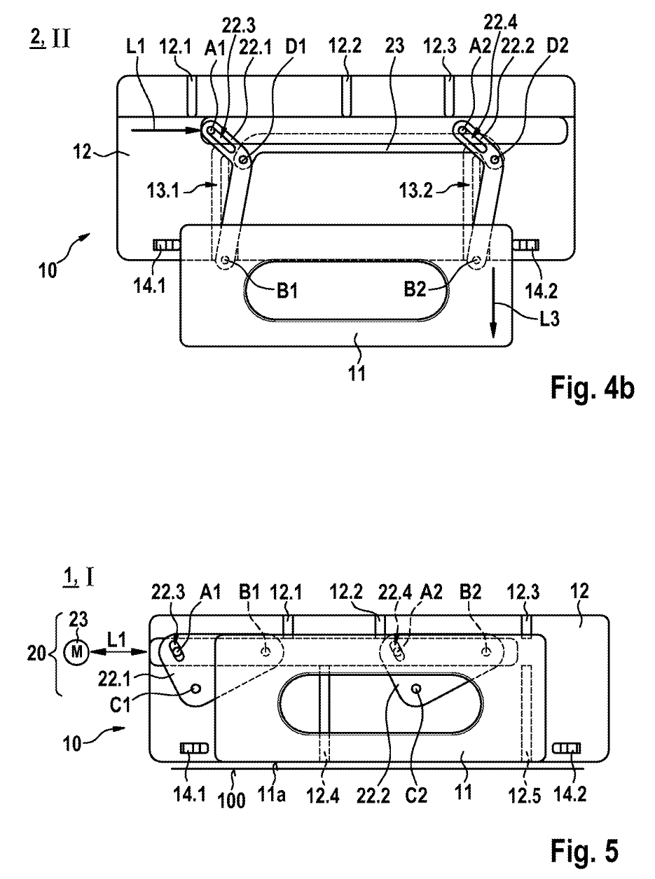

FIG. 5 shows, by way of example, a further embodiment of the handle device according to the invention,

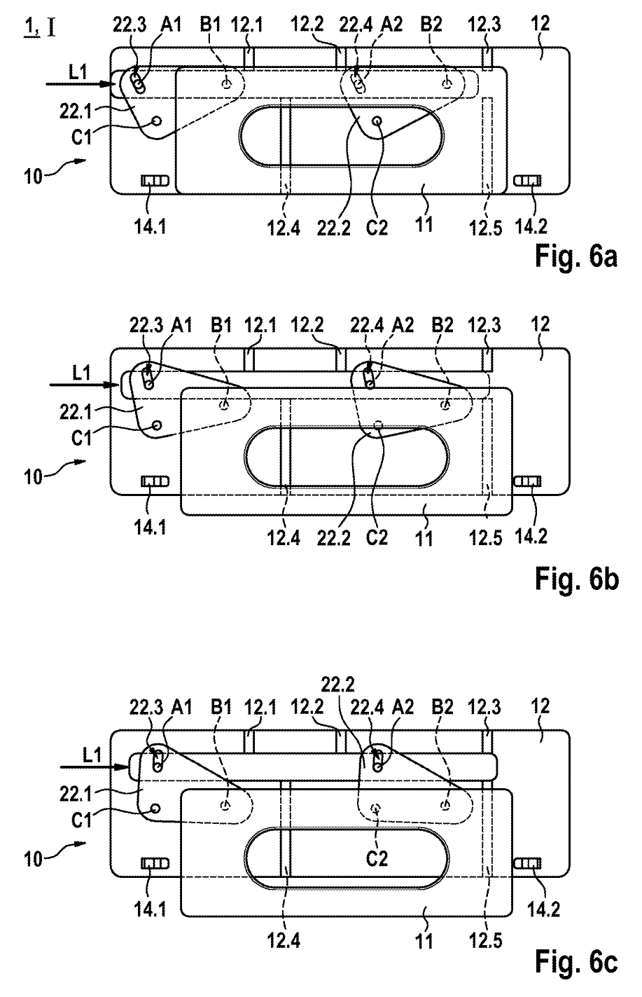

FIGS. 6a to 6e show, by way of example, a displacement path of the grip part between the resting position and the operating position using the handle device according to FIG. 5,

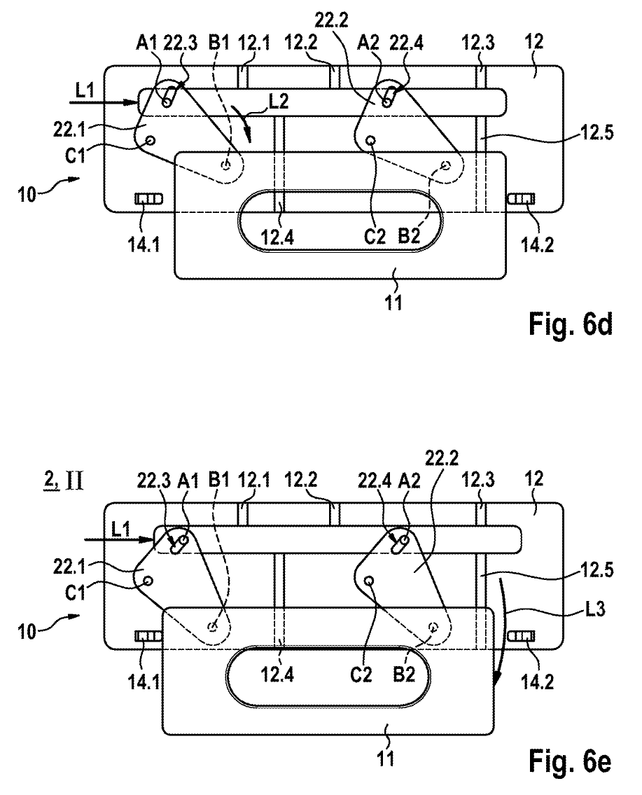

FIG. 7 shows the handle device according to the invention according to FIG. 5, having the grip part in the operating position,

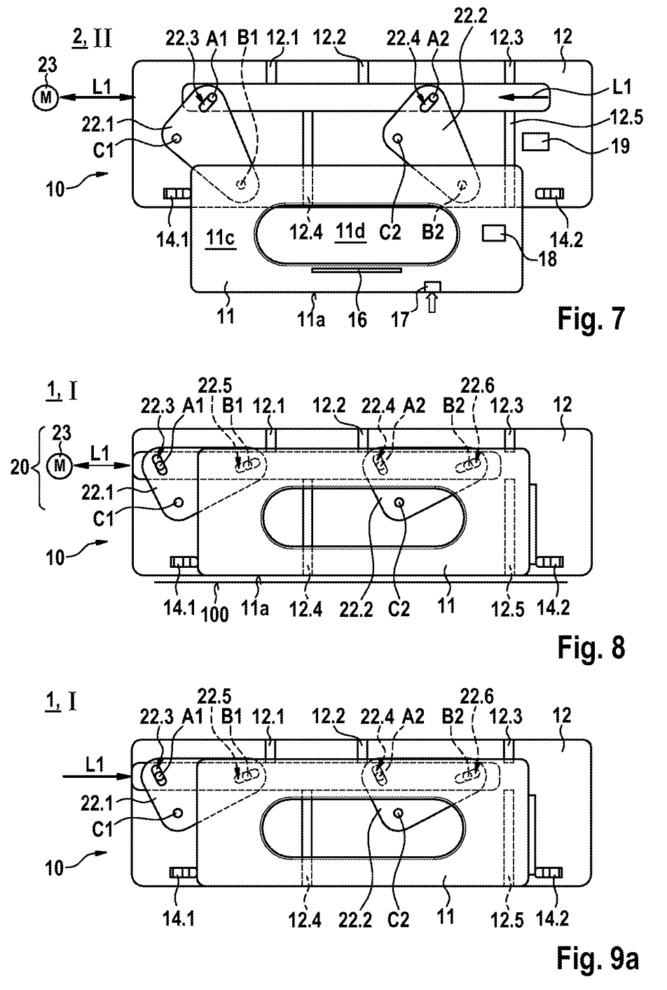

FIG. 8 shows, by way of example, a further embodiment of the handle device according to the invention,

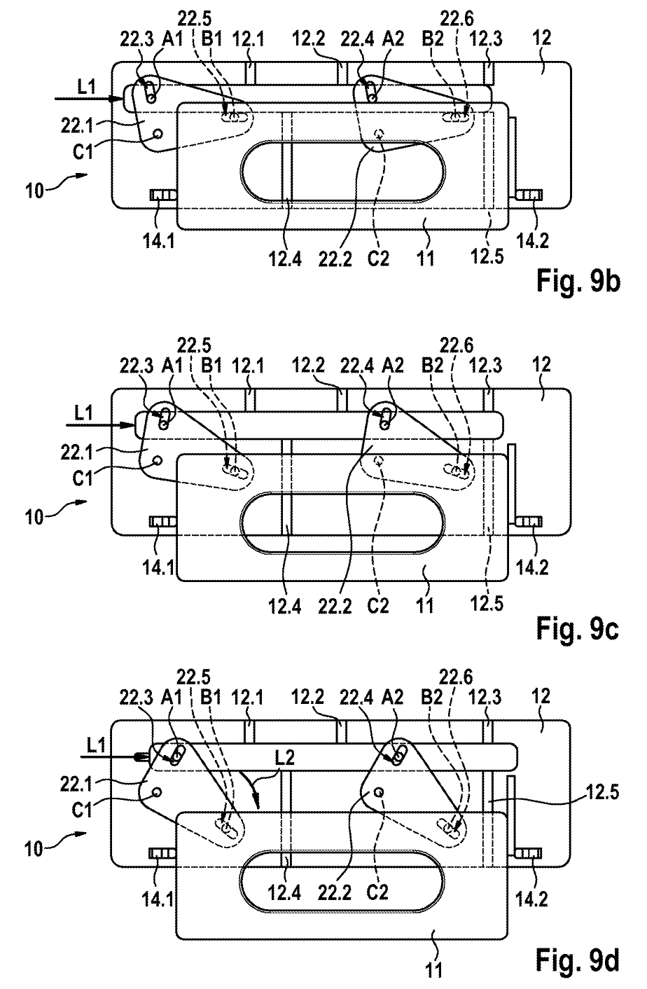

FIGS. 9a to 9e show, by way of example, a displacement path of the grip part between the resting position and the operating position using the handle device according to FIG. 8, and

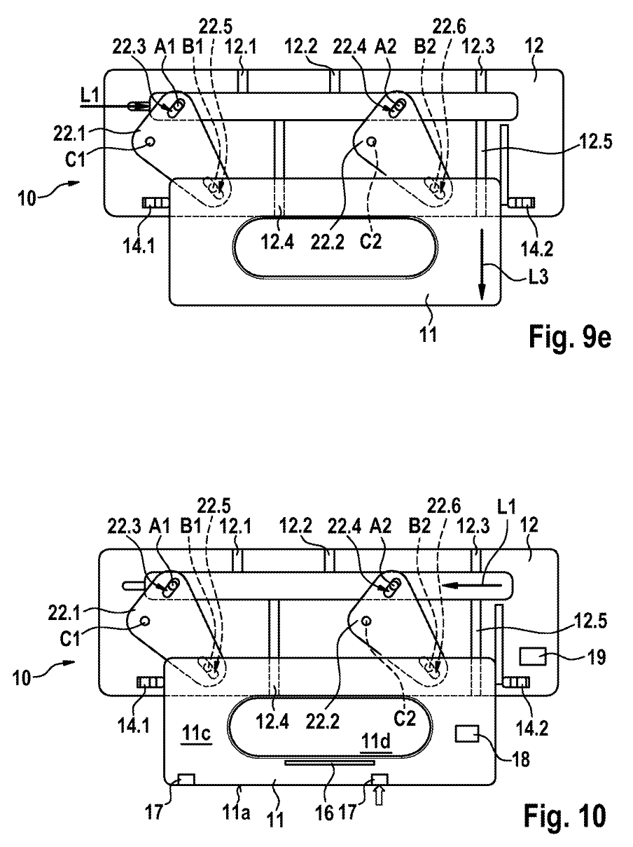

FIG. 10 shows the handle device according to the invention according to FIG. 8, having the grip part in the operating position.

FIG. 1a to 3 show a device 10 according to the invention, comprising a flush-mounted grip part 11 in a resting position I. The grip part 11 is used, according to the invention, for activating, for example for opening, a movable part, such as a vehicle door. In this case, the handle device 10 is fastened to a carrier element 12 which can function as a housing or as a frame structure for fastening the handle device 10 to the movable part. In order to be able to use the grip part 11, an actuation unit 20 can actuate the grip part 11 between a flush-mounted resting position I shown in FIG. 1a and FIG. 2a, and an operating position II shown in FIG. 2e and FIG. 3. As can be seen in FIG. 1a, in the resting position I an outer side 11a of the grip part 11 is flush-mounted on an outer side 100 of the movable part. In the operating position II, shown in FIGS. 2e and 3, the grip part 11 is extended out of an opening 101 in the outer side 100 of the movable part, the grip part 11 being able to be used, in said extended operating position II, for opening the movable part. In this case it is conceivable that the grip part 11 may still be able to be pulled slightly further out of the opening 101 in the outer side 100 of the movable part, in order to open the movable part. Alternatively, however, it is also conceivable that the grip part 11 may comprise a contactless, for example capacitive, sensor 16, the monitoring region of which can be oriented into a handle recess 11d on the grip part 11 in order to automatically open the movable part by means of grasping into the handle recess 11d.

In this case, the actuation unit 20 is configured such that the outer side 11a of the grip part 11 is always displaced in parallel with the outer side 100 of the movable part, between the resting position I and the operating position II of the grip part 11. In this case, the actuation unit 20 comprises an actuation element 21 in the form of a drive shaft or a drive rod, and just one double transmission element 22.1, 22.2 for transmitting the actuation effect from a linear drive 23 to the grip part 11 in a simple and stable manner. In this case, the double transmission element 22.1, 22.2 forms a single transmission link between the actuation element 21 and the grip part 11. In this case, the linear drive 23 causes a translational movement of the actuation element 21 along the line L1 which extends in parallel with the outer side 100 of the movable part and in parallel with the outer surface 11a of the grip part 11. A translational movement along the outer side 100 of the movable part enables to make use of the installation space along the outer side 100 of the movable part and to reduce the installation space in the direction perpendicular to the movable part, which space is limited. In this case, the actuation element 21 can be displaced between a retracted position 1, shown in FIGS. 1a and 2a, and an extended position 2, shown in FIGS. 2e and 3. In the retracted position 1 of the actuation unit 21 the grip part 11 is in the resting position I, and in the extended position 2 of the actuation unit 21 the grip part 11 is in the operating position II. The movement sequence of the actuation unit 20 and the displacement path L3 of the grip part 11 will be explained in the following, with reference to FIGS. 2a to 2e.

According to the invention, the actuation unit 20 can manage with just one transmission element 22.1, 22.2 for transmitting the actuation effect from the actuation element 21 to the grip part 11. In this case, two symmetrical transmission elements 22.1, 22.2 are advantageous in order to transmit the actuation effect to the grip part 11 on both sides and thus allow for a stable, specified displacement path L3 of the grip part 11 between the res position I and the operating position II. In this case, a first transmission element 22.1 is arranged to the left-hand side and a second transmission element 22.2 is arranged to the right-hand side of the grip part 11. The two transmission elements 22.1, 22.2 constitute the same transmission link in the drive chain according to the invention, which transmission link is merely doubled in order to surround the grip part 11 on both sides. In this case, the two transmission elements 22.1, 22.2 act synchronously to one another and are used to form two symmetrical points of application A1, A2 on the actuation element 21 in order to pick up the actuation effect. In this case, the transmission elements 22.1, 22.2 are pivotably connected to the actuation element 21 at a first axis A1, A2 in each case. The two transmission elements 22.1, 22.2 are furthermore used to form two symmetrical points of application B1, B2 on the grip part 11 in order to symmetrically transmit the actuation effect from the actuation element 21 to the grip part 11 and to thus stabilize said effect. In this case, the transmission elements 22.1, 22.2 are connected to the grip part 11 at a second pivotable axis B1, B2 in each case. It is advantageous in this case that even an elongate grip part 11 can be actuated in a uniform and thus error-free manner using two end transmission elements 22.1, 22.2. The pivotable connection between the actuation element 21 and the relevant transmission element 22.1, 22.2, and between the relevant transmission element 22.1, 22.2 and the grip part 11 means that the actuation effect can be transmitted at a variable angle. In the embodiment of FIG. 1a, a linear movement of the actuation element 21 along the line L1 is transformed into a curved movement L2 of the relevant transmission element 22.1, 22.2 and finally into a linear movement L3 of the grip part 11 perpendicularly to the outer side 100 of the movable part.

The transmission element 22.1, 22.2 according to the embodiment of FIG. 1a is configured in the form of a straight lever, wherein the transmission element 22.1, 22.2 can be formed as a curved transmission element 22.1, 22.2, as is shown subsequently in the embodiment of FIGS. 4a and 4b, for example in order to reduce the necessary installation space in the direction perpendicular to the outer side 100 of the movable part.

According to the embodiment of FIG. 1a, the carrier element 12 of the handle device 10 according to the invention is formed having two symmetrical slotted guides 13.1, 13.2 in order to support, and thus stabilize, the movement of the grip part 11 between the resting position I and the operating position II on both sides. However, it would be equally conceivable that just one slotted guide 13.1, 13.2 could suffice for supporting the linear movement of the grip part 11. Furthermore, in FIG. 1b, the slotted guides 13.1, 13.2 are shown in a view, from the end side, of the opening 101 in the outer side 100 of the movable part, out of which opening the grip part 11 can be extended into the operating position II thereof. In this case, the slotted guides 13.1, 13.2 are oriented so as to be perpendicular to the outer side 100 of the movable part and to the outer surface 11a of the grip part 11 and contribute to implementing the movement of the outer surface 11a of the grip part 11 between the resting position I and the operating position II so as to always be in parallel with the outer side 100. One cam 11.1, 11.2 in each case, which is molded on below the grip part 11 and with which the relevant slotted guide 13.1, 13.2 can engage, interacts with the relevant slotted guide 13.1, 13.2.

As FIG. 1a furthermore shows, the carrier element 12 can be formed having a plurality of stop elements 12.1, 12.2, 12.3, 14.1, 14.2 for limiting the movement of the grip part 11 to the sides of the grip part 11 using lateral stop elements 14.1, 14.2 and to the rear using rear stop elements 12.1, 12.2, 12.3. In further embodiments of the invention, shown in FIGS. 5 to 10, further stop elements 12.4, 12.5 may be provided on the carrier element 12, below the grip part 11, in order to facilitate sliding of the grip part 11 on the carrier element 12 by means of the contact surface between the grip part 11 and the carrier element 12 on the stop elements 12.4, 12.5 being reduced.

FIG. 1c shows a further embodiment of the invention comprising a prominent stop surface 21b on the actuation element 21, which surface can, in an emergency, for example in the event of the grip part 11 freezing inside the opening 101, be brought into operative connection with an emergency element 11b on the grip part 11 in order to assist the transfer of the grip part 11 out of the resting position I and into the operating position II. However, under normal circumstances, shown in FIG. 1c, the emergency element 11b is spaced apart from the stop surface 21b. In this case, each transmission element 22.1, 22.2 is formed having a slot 22.3, 22.4, respectively, at the point of application A1, A2 on the actuation element 21 in order to implement a certain amount of overrun for the actuation element 21, in the event of the grip part 11 freezing in the opening 101 in the movable part, until the stop surface 21b of the actuation element 21 can be brought into operative engagement with the emergency element 11b of the grip part 11. An ice-breaker function, for example, can thus be implemented, in that the stop surface 21b of the actuation element 21 can additionally transmit the actuation effect to the emergency element 11b of the grip part 11. The relevant slot 22.3, 22.4 can furthermore achieve the advantage that the grip part 11 can be pulled out a little further of the operating position II in order to cause the movable part to be opened.

FIGS. 2a to 2e show the movement sequence of the grip part 11 between the resting position I and the operating position II according to the embodiment of the handle device 10 according to FIG. 1a. In this case, the actuation element 21 is actuated in a linear manner along the line L1. In FIG. 2a, the actuation element 21 is in the retracted position 1 thereof. In this case, the actuation element 21 and the transmission element 22 are arranged so as to be at an acute angle relative to one another. Between the position according to FIG. 2a and the position according to FIG. 2e, the actuation element 21 is displaced from left to right, as far as the outermost position thereof or as far as the extended position 2 thereof. While the actuation element 21 moves from left to right, the transmission elements 22.1, 22.2 are pivoted downwards along the arrow L2 about the first axes A1, A2, respectively, such that the grip part 11 can be displaced in a linear manner along the line L3, from the top, out of the resting position I thereof according to FIG. 2a, downwards into the operating position II according to FIG. 2e. The deflection of a pivotable movement of the transmission element 22.1, 22.2 into a linear movement of the grip part 11 is possible owing to a pivotable connection between the transmission elements 22.1, 22.2 and the grip part 11 at the second axes B1, B2, respectively. Furthermore, the guides 13.1, 13.2 on the carrier element 12 assist the translational movement sequence of the grip part 11 along the line L3 at least in part.

FIG. 3 shows the grip part 11 according to the invention in the operating position II. In this case, it can be seen that, in the operating position II of the grip part 11, the actuation element 21 and the transmission element 22.1, 22.2 are arranged so as to be approximately mutually perpendicular. An orientation of this kind of the actuation element 21 relative to the transmission element 22.1, 22.2 prevents undesired abrupt transfer of the grip part 11 out of the operating position II and into the resting position I. In this case, the actuation unit 20 provides a self-locking effect against the transmission element 22.1, 22.2 abruptly striking the actuation element 21. In this case, it is conceivable that, in the operating position II of the grip part 11, an angle α between the actuation element 21 and the transmission element 22.1, 22.2 may be close to 90°, for example between 75° and 90°, in particular 80° to 88°, preferably 84° to 86°. An orientation of this kind of the actuation element 21 relative to the transmission element 22.1, 22.2 can be released again only by means of deliberate and moderate manipulation of the grip part 11 or of the actuation unit 20 within the meaning of the invention. A movement sequence of this kind can be implemented in reverse, from the position according to FIG. 2e back into the position according to FIG. 2a, in order to transfer the grip part 11 out of the operating position II and into the resting position I.

FIG. 3 furthermore shows that a first spring element 15.1 may be provided on the actuation element 21 in order to load the actuation element 21 out of the extended position 2 according to FIG. 3 or FIG. 2e and into the retracted position according to FIG. 1a or FIG. 2a. It is thereby possible to ensure that the actuation element 21 can still be transferred into the retracted position 1 according to FIG. 1a or FIG. 2a, despite an approximately perpendicular orientation relative to the transmission element 22.1, 22.2. FIG. 3 further shows that a second spring element 15.2 may be provided on the grip part 11 in order to load the grip part 11 out of the operating position II and into the resting position I. It is thereby possible to ensure that the grip part 11 can be transferred out of the operating position II and into the resting position I by means of slow and deliberate manipulation, despite the self-locking orientation of the actuation element 21 relative to the transmission element 22.1, 22.2. For this purpose, it is possible, according to the invention, that the grip part 11 may be able to be manually transferred out of the operating position II and into the resting position I, for example by pressing the grip part along the arrow L3. Alternatively, however, it is also conceivable that a switch 17 may be provided, which switch can be activated in order to automatically transfer the grip part 11 out of the operating position II and into the resting position I. A switch 17 of this kind is shown by way of example in FIGS. 3, 7 and 10.

Moreover, FIGS. 3, 7 and 10 show that the grip part 11 may comprise a contactless, for example capacitive, sensor 16 for automatically initiating opening of the movable part if a user's hand grasps inside the handle recess 11d on the grip part 11. This can allow for simple and intuitive manipulation of the movable part, even without pulling the grip part 11. In addition, the grip part 11 may comprise a further contactless sensor 18, for example on an upper flat side 11c, in order to automatically initiate retraction of the grip part 11 and locking of the movable part by lightly tapping the sensor 18 or by simply approaching the sensor 18. The manipulation of the grip part 11 can thus be fully automated and the use of the handle device 10 can be made more comfortable. In this case, it is conceivable that the handle device 10 may be part of a Keyless-Go system of a motor vehicle which can in particular lock and/or unlock the movable part without a mechanical lock cylinder. An automatic system can thus be provided for unlocking or for locking the movable part without actively using a car key. An automatically extending and retracting grip part 11 according to the handle device 10 according to the invention can advantageously increase the operating comfort of the motor vehicle still further. In this case it is conceivable that the handle device 10 may comprise a transceiver unit 19, for example on the carrier element 12, for executing a user authorization request. The authorization of a user who is approaching in order to open the movable part can thus advantageously be requested directly in the vicinity of the grip part 11.

FIGS. 4a and 4b show a further embodiment of the handle device 10 according to the invention, according to which the transmission elements 22.1, 22.2 may be curved. As a result, the installation space of the handle device 10 in the direction perpendicular to the outer side 100 of the movable part, which space is usually limited, can be reduced. FIGS. 4a and 4b furthermore show that a connecting element 23 in the form of a connecting rod may be provided between the two transmission elements 22.1, 22.2 in order to synchronize the movement of the transmission elements 22.1, 22.2. The connecting element 23 can be oriented so as to be substantially in parallel with the outer side 100 of the movable part and with the outer surface 11a of the grip part 11. In this case, the connecting element 23 ensures that the actuation effect is transmitted uniformly from the actuation element 21 to the two transmission elements 22.1, 22.2. In this case, the connecting element 23 may in part imitate the movement of the grip part 11 according to FIGS. 2a to 2e in that the connecting element 23 is displaced downwards in a manner substantially in parallel with the outer side 100 of the door. In this case, the connecting element 23 is pivotably mounted about a fourth axis D1, D2 in each case, by means of the first connecting element 22.1 and by means of the second connecting element 22.2.

FIG. 5 shows a further embodiment of the handle device 10 according to the invention, according to which the at least one transmission element 22.1, 22.2 is configured in the form of a triangle. The transmission element 22.1, 22.2 can thus form three points of application in order to engage on the actuation element 21 by means of one point of application A1, A2, to engage on the grip part 11 by means of a second point of application B1, B2, and finally to form a fixed axis C1, C2 by means of a third point of application C1, C2, which axis can be used for pivotably fastening the transmission element 22.1, 22.2 to the carrier element 12. In this case, the third axis C1, C2 can function as a support point for the transmission element 22.1, 22.2 on the carrier element 12. The transmission element 22.1, 22.2 can thus be actuated in a more stable and more reliable manner, and the actuation effect can consequently be transmitted to the grip part 11 in a more stable and more reliable manner. According to this embodiment of the handle device, the linear movement of the actuation element 21 can be transformed into a curved movement L2 of the transmission element 22.1, 22.2.

In the embodiment according to FIG. 5 the grip part 11 is, as shown in FIGS. 6a to 6b, likewise moved in a curved manner L3, the outer surface 11a of the grip part 11 always being displaced in parallel with the outer side 100 of the movable part in each position of the grip part 11 between the resting position according to FIG. 6a and the operating position II according to FIG. 6e. As a result, the grip part 11 can be prevented from pausing. At the point of application A1, A2, the relevant transmission element 22.1, 22.2 is formed having one slot 22.3, 22.4, respectively, towards the actuation element 21 in order to receive the first axis A1, A2, which is movable with the actuation element 21, in a pivotable manner and so as to be linearly movable in the slot 22.3, 22.4. As a result, it is thus possible that a linear movement of the actuation element 21 may be transformed into a curved movement L2 of the transmission element 22.1, 22.2. In this embodiment, the slotted guides 13.1, 13.2 can be omitted in order that the grip part 11 can carry out the curved movement L3 between the two stop elements 14.1, 14.2.

FIG. 7 finally shows the grip part 11 in the operating position II according to FIG. 6e. The actuation element 21 can be displaced out of the extended position 2 and back into the retracted position 1 according to FIGS. 5 and 6a by means of a movement of the actuation element 21 back along the arrow L1. In this case, the grip part 11 can be manipulated manually by pressing along the arrow L3, or automatically using a switch 17. In this embodiment, too, a sensor 16 for automatically opening the movable part and a sensor 18 for automatically retracting the grip part 11 and for locking the movable part may be provided.

As is shown by FIGS. 8 to 10, the invention may further provide a further embodiment of the handle device 10 according to the invention, according to which the at least one transmission element 22.1, 22.2 may comprise a slot, in particular one slot 22.5, 22.6, respectively, towards the grip part 11, in order to receive the second axis B1, B2, which is movable with the grip part 11, in a pivotable manner and so as to be linearly movable in the slot 22.5, 22.6. The curved movement L2 of the transmission element 22.1, 22.2 can thus be transformed into a linear movement L3 of the grip part 11 out of the resting position I and into the operating position II, as shown in FIGS. 9a to 9e. A linear movement L3 of the grip part 11 can be easily and reliably supported on the carrier element 12, for example using a slotted guide 13.1, 13.2 or a stop guide 14.2. A linear movement L3 of the grip part 11 is furthermore advantageous because it is the least susceptible to error. Together with the stop element 14.1, the stop guide 14.2 according to FIGS. 9a to 9e can limit, and thus support, the movement of the grip part 11 from two end sides. As a result, at least one continuous stop can be created on one end side of the grip part 11.

FIG. 10 finally shows the grip part 11 in the operating position according to FIG. 9e. By moving the actuation element 21 back along the arrow L1, the actuation element 21 can be displaced out of the extended position 2 and back into the retracted position 1 according to FIGS. 8 and 9a. In this case, the grip part 11 can be manipulated manually by pressing along the arrow L3, or automatically using a switch 17, in order to be displaced out of the operating position II and back into the resting position I. In this embodiment, too, a sensor 16 for automatically opening the movable part and a sensor 18 for automatically retracting the grip part 11 and for locking the movable part may be provided.

Finally, it should be noted that the embodiments described above can be combined with one another as desired, and therefore the features that have been disclosed with reference to one embodiment may also be present in another embodiment.

### LIST OF REFERENCE CHARACTERS

10 handle device
11 grip part
11a outer surface of the grip part
11b emergency element on the grip part
11c upper flat side of the grip part
11.1 cam
11.2 cam
12 carrier element
12.1 rear stop element
12.2 rear stop element
12.3 rear stop element
13.1 slotted guide
13.2 slotted guide
14.1 end stop element
14.2 end stop element/stop guide
15.1 first spring element
15.2 second spring element
16 sensor for opening a movable part
17 switch for transferring the grip part out of an operating position and into a resting position
18 sensor for locking the movable part
20 actuation unit
21 actuation element/drive rod/drive shaft
21b stop surface on the actuation element
22.1 first transmission element
22.2 second transmission element
22.3 slot on the first transmission element, towards the actuation element
22.4 slot on the second transmission element, towards the actuation element
22.5 slot on the first transmission element, towards the grip part
22.6 slot on the second transmission element, towards the grip part
23 connecting element/connecting rod
100 outer side of the movable part/outer side of the door
101 opening for the grip part
A1 first movable axis on the actuation element for the first transmission element
A2 first movable axis on the actuation element for the second transmission element
B1 second axis, movable with the grip part, for the first transmission element
B2 second axis, movable with the grip part, for the second transmission element
C1 third fixed axis on the carrier element for the first transmission element
C2 third fixed axis on the carrier element for the second transmission element
D1 fourth movable axis on the first transmission element for the connecting element
D2 fourth movable axis on the second transmission element for the connecting element
L1 linear movement of the actuation element
L2 pivotable movement of the transmission element
L3 linear/curved movement of the grip part
α angle between the actuation element and the transmission element in the operating position of the grip part
I resting position of the grip part
II operating position of the grip part
1 retracted position of the actuation element
2 extended position of the actuation element

1. A handle device for a movable part comprising
a grip part for activating the movable part,
a carrier element for fastening the handle device to the movable part,
wherein the grip part is mounted on the carrier element so as to be movable between a resting position and an operating position,
wherein, in the resting position, the grip part can be arranged such that an outer surface thereof is flush-mounted with an outer side of the movable part,
wherein, in the operating position, the grip part can be extended out of an opening in the outer side of the movable part,
and wherein, in the operating position, the grip part can be used for opening the movable part,
and an actuation unit for actuating the grip part between the resting position and the operating position,
wherein the actuation unit is configured such that the outer surface of the grip part can always be displaced in parallel with the outer side of the movable part, between the resting position and the operating position.

2. The handle device according to claim 1,
wherein
the actuation unit comprises a linear drive.

3. The handle device according to claim 1,
wherein
the actuation unit comprises an actuation element.

4. The handle device according to claim 1,
wherein
the actuation unit comprises at least one transmission element for transmitting the actuation effect from the actuation element to the grip part.

5. The handle device according to claim 1,
wherein
the actuation unit comprises two transmission elements which engage on the actuation element at the end thereof.

6. The handle device according to claim 5,
wherein
a connecting element, is provided between the two transmission elements in order to synchronize the movement of the transmission elements.

7. The handle device according to claim 1,
wherein
the at least one transmission element is mounted on the actuation element so as to be pivotable about a first axis at least that is movable with the actuation element or is mounted on the grip part so as to be pivotable about a second axis that is movable with the grip part.

8. The handle device according to claim 1,
wherein
the actuation element comprises at least one stop surface which can, in an emergency, be brought into operative connection with the grip part in order to assist the actuation effect on the grip part.

9. The handle device according to claim 1,
wherein
the grip part comprises at least one emergency element which, in an emergency, can be brought into operative connection with the stop surface in order to assist the actuation effect on the grip part.

10. The handle device according to claim 1,
wherein
the at least one transmission element is configured in the form of a straight or curved lever.

11. The handle device according to claim 1,
wherein
the carrier element comprises at least one slotted guide for stabilizing the movement of the grip part between the resting position and the operating position.

12. The handle device according to claim 11,
wherein
the at least one slotted guide, is configured so as to allow a movement of the grip part substantially perpendicularly to the outer side of the movable part and to the outer surface of the grip part.

13. The handle device according to claim 11,
wherein
the grip part comprises a cam, which mesh with the slotted guide.

14. The handle device according to claim 1,
wherein
the carrier element comprises at least one stop element for stabilizing the movement of the grip part, between the resting position and the operating position.

15. The handle device according to claim 1,
wherein
the actuation unit is configured so as to be self-locking.

16. The handle device according to claim 1,
wherein
in the operating position of the grip part, the actuation element and the at least one transmission element can be arranged so as to be at an angle of from 75° to 90° relative to one another, in order to prevent undesired transfer of the grip part from the operating position into the resting position.

17. The handle device according to claim 1,
wherein
at least one spring element is provided in order to support the movement of the grip part from the operating position and into the resting position.

18. The handle device according to claim 1,
wherein
a first spring element strikes the actuation element in order to load the actuation element out of an extended position and into a retracted position, wherein the grip part is in the resting position when the actuation element is in the retracted position, and the grip part is in the operating position when the actuation element is in the extended position.

19. The handle device according to claim 1,
wherein
a second spring element strikes the grip part in order to load the grip part out of the operating position and into the resting position.

20. The handle device according to claim 1,
wherein
the at least one transmission element is configured in the form of a triangle.

21. The handle device according to claim 1,
wherein
the at least one transmission element comprises a slot, respectively, towards the actuation element in order to receive a first axis, which is movable with the actuation element, in a linearly movable and pivotable manner.

22. The handle device according to claim 1, wherein the at least one transmission element is mounted on the carrier element so as to be pivotable about a third, fixed axis, respectively.

23. The handle device according to claim 1,
wherein
the at least one transmission element comprises a slot respectively, towards the grip part, in order to receive the second axis, which is movable with the grip part, in a pivotable manner and so as to be linearly movable.

24. The handle device according to claim 1,
wherein
the carrier element comprises at least one stop guide in order to stabilize the movement of the grip part between the resting position and the operating position.

25. The handle device according to claim 1,
wherein
at least the grip part comprises a sensor for automatically initiating opening of the movable part when a user's hand grasps a handle recess,
or wherein the grip part comprises a switch on the outer surface for automatically initiating a transfer of the grip part out of the operating position and into the resting position,
or wherein the grip part comprises a sensor on an flat side, for automatically initiating transfer of the grip part out of the operating position and into the resting position, and locking of the movable part.

26. The handle device according to claim 1,
wherein
the handle device is formed as a component of a Keyless-Go system of a motor vehicle.

27. The handle device according to claim 1,
wherein
the handle device comprises a transceiver unit for executing a user authorization request.
